(19) United States
(12) Patent Application Publication
(10) Pub. No.: US 2002/0060107 A1
(43) Pub. Date: May 23, 2002

(54) Backpack frame for mounting blower having noise suppressing effect

(76) Inventors: Tadashi Kamoshita, Asaka-shi (JP); Masanori Ohtani, Tokyo (JP); Robert Scott Stegall, Lake Villa, IL (US)

Correspondence Address: Michael D. Bednarek, SHAWPITTMAN, 2300 N Street, N.W., Washington, DC, 20037-1128, US

(21) Appl. No.: 09/987,028

(22) Filed: Nov. 13, 2001

(30) Foreign Application Priority Data
Nov. 21, 2000 (JP) 2000-354055

(51) Int. Cl. F02K 11/00; B64D 33/02

(52) U.S. Cl. 181/214; 181/224; 181/225; 181/200

(57) ABSTRACT

A backpack frame for mounting a blower having an inlet port is provided with an intake air muffler on a surface facing the inlet port. The intake air muffler may be formed of a large number of through holes which are communicated with the backpack frame and have a small diameter and no angular portions, or a large number of dimples with a small diameter formed on the surface.

### BACKGROUND

1. Field of the Invention

The present invention relates to a backpack frame with a blower mounted thereon, and particularly, to a backpack frame having an effect of suppressing the noise generated by the intake air of the blower. The backpack frame in accordance with the present invention constitutes a backpack type working machine including a backpack type power blower.

2. Background of the Invention

In one kind of backpack type working machine, for example, in a backpack type power blower, major components such as an internal combustion engine, a blower such as a centrifugal blower, and a fuel tank are mounted on the backpack frame. An operator carries the backpack frame on his back and blows away mown grasses, withered leaves, etc. by the air output by the blower.

When the backpack type power blower is in operation, noise is generated from the rotation of a fan of the blower. Additional noise is generated when intake air flows through the fan. In addition, noise is generated by the internal combustion engine.

### SUMMARY OF THE INVENTION

A backpack frame in accordance with the present invention is used for mounting a blower having an inlet port thereon, and has an intake air muffler on a surface facing the inlet port. It is an object of the present invention to reduce the noise generated by the intake air of a blower.

The backpack frame according to an embodiment of the present invention comprises a back support and a base plate for the operator to carry the blower having the inlet port on his back, and further comprises the intake air muffler on a surface facing the inlet port.

A backpack type working machine according to an embodiment of the present invention comprises a backpack frame with a blower having an inlet port and an engine to drive the blower mounted thereon, and an intake air muffler on a surface of the backpack frame facing the inlet port.

In the backpack frame and the backpack type working machine, the muffling effect is achieved by sucking the air into the inlet port through an installation area of the intake air muffler.

In an embodiment, the intake air muffler can be formed of a large number of through holes communicated with a cavity formed in the backpack frame. In this configuration, even when the air pressure fluctuation is generated in the air sucked from the inlet port, the air is sucked or exhausted through the large number of through holes communicated with the cavity, and rectified in the flow direction to prevent the generation of the noise.

Preferably, each of the large number of through holes is a through hole with a small diameter having no angular portions. In this configuration, the through holes have no angular portions, and no noise is generated when the sucked air passes through a vicinity of the through holes. In addition, the through holes are small, and the strength of the backpack frame is not reduced.

In an embodiment, a sound absorbing material can be filled in the cavity. In this configuration, a part of the air sucked to the inlet port is led into the sound absorbing material, and the noise can be further attenuated.

In another embodiment, the intake air muffler can be a large number of dimples with a small diameter formed in the surface. In this configuration, the strength of the backpack frame is not degraded, and the backpack frame can be easily manufactured.

In an embodiment, the surface is equipped with an intake air guide portion which is raised toward the inlet port, and the periphery of the intake air guide portion is smoothly curved in order to increase the air intake efficiency to the inlet port.

### BRIEF DESCRIPTION OF THE DRAWINGS

FIG. 1 is a partly perspective view of a backpack frame according to an embodiment of the present invention.

FIG. 2 is a longitudinal sectional view of a major portion of the backpack frame in an assembling step in FIG. 1.

FIG. 3 is a cross-sectional view of a major portion of a backpack type power blower using the backpack frame according to an embodiment of the present invention.

FIG. 4 is an enlarged cross-sectional view of a major portion of an intake air muffler according to another embodiment.

### DETAILED DESCRIPTION OF THE INVENTION

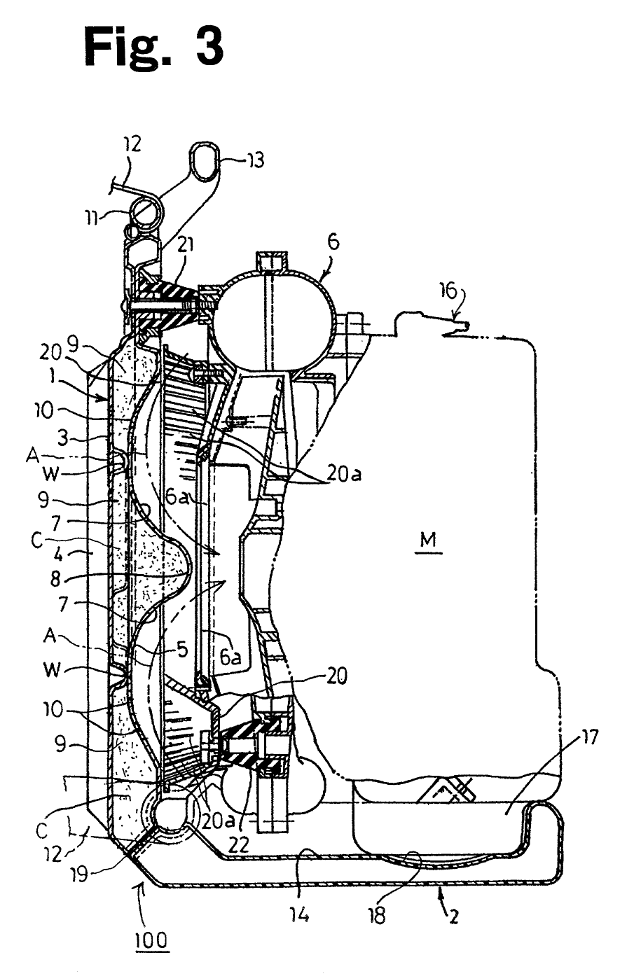

As shown in FIG. 3, a backpack frame 100 according to an embodiment of the present invention is used for a backpack type power blower as a backpack type working machine. The backpack frame 100 is adapted to receive a working machine M. The backpack frame 100 comprises a back support 1 and a base plate 2. The back support and the base plate 2 are preferably assembled in an L-shape. The working machine M has a centrifugal blower 6, an engine 16, e.g., an air-cooled two-cycle internal combustion engine, to drive the centrifugal blower 6, and a fuel tank 17. The working machine M is preferably mounted on the backpack frame 100 in a vibration isolating manner. The centrifugal blower 6 is preferably mounted on the back support 1 via vibration isolating members 21 and 22. Preferably, the working machine M is mounted with an inlet port 6a facing a surface (a back surface) 5 on the base plate 2 side of the back support 1. The engine 16 is drive-connected to the centrifugal blower 6, and supported by the base plate 2.

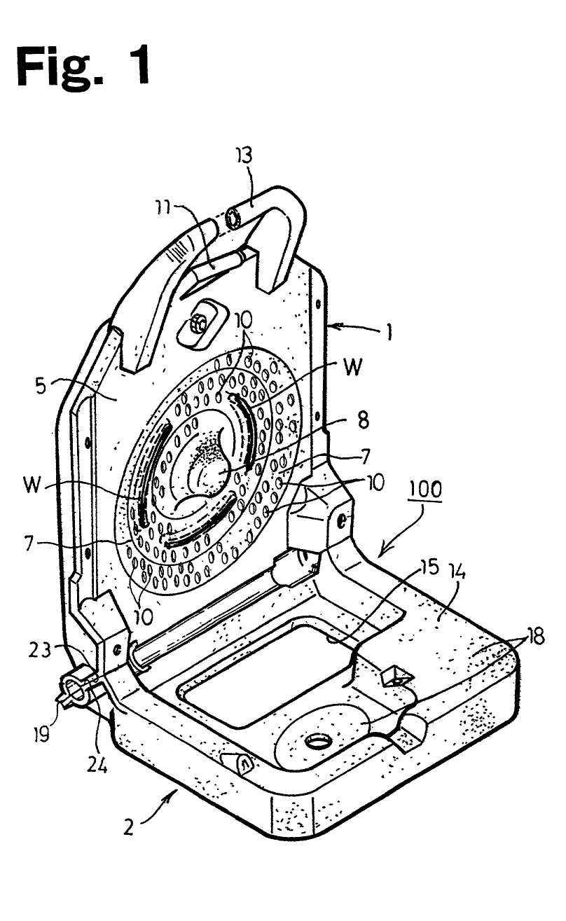

As shown in FIG. 1, the back support 1 is preferably substantially square as a whole. As shown in FIG. 3, a cushioning member 4 is preferably mounted on a front surface 3 forming a back-touching side of the back support 1. The cushioning member 4 is adapted to reduce vibration experienced by a user of the backpack frame 100. Furthermore, it also increases a comfort level for the operator when using the backpack frame 100.

A protruded air intake guide portion 8 is preferably formed in a center portion of the back surface 5 of the back support 1. The protruded air intake guide portion 8 is raised toward the center portion of the inlet port 6a of the centrifugal blower 6, and equipped with a smoothly curved surface 7 to increase the air intake efficiency to the inlet port 6a. The back support 1 preferably has a cavity 9 inside. Preferably, sound absorbing material C is filled in the cavity 9 as necessary to increase the sound absorbing effect. One example of the sound absorbing material is a sponge.

A number of through holes 10 communicated with the cavity 9 are preferably formed in the back surface 5 of the back support 1. These through holes 10 serve as an intake air muffler to reduce noise that is generated when intake air flows into the inlet port 6a. In the embodiment shown in FIGS. 1-4, the through holes 10 are preferably through holes with a small diameter having no angular portions. In other words, the through holes 10 are preferably small circular or elliptical holes. Preferably, the through holes 10 are formed only in the curved surface 7. Preferably, the through holes 10 can also be formed in the protruded air intake guide portion 8.

As shown in FIG. 1, the base plate 2 is also preferably hollow, preferably square as a whole, and provided in the horizontal direction on a lower end of the back support 1. A window hole 15 located below the centrifugal blower 6 is formed in the base plate 2. A support portion 18 of the engine 16, the fuel tank 17, etc. is formed on an upper surface 14 of the base plate 2.

In FIG. 3, numeral 11 denotes a fitting portion of a shoulder strap 12, and numeral 13 denotes a portable handle. Numeral 20 denotes a collar-like grid having a large number of long ventilation holes 20a. The collar-like grid 20 is preferably disposed between the periphery of the inlet port 6a of the centrifugal blower 6 and the back support 1. The collar-like grid 20 prevents withered leaves and other debris from being sucked into the centrifugal blower 6. In FIG. 3, an arrow A denotes an intake air flow-in passage. In addition, various kinds of control levers can be mounted on the base plate 2 although they are not shown in detail.

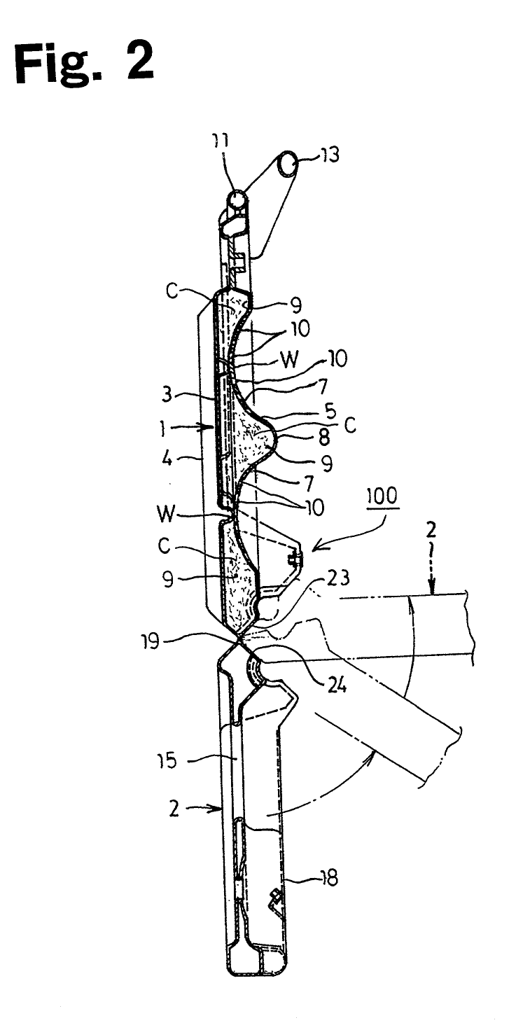

Next, an example of a manufacturing method of the backpack frame 100 will be described below. The backpack frame 100 can be integrally blow-molded in a plate by using a plastic material as shown in FIG. 2. In the blow-molded state, the back support 1 and the base plate 2 preferably have a thin-walled hollow box shape. The back support 1 and the base plate 2 are preferably integrated with each other via a flexible thin-walled portion 19. A reinforcing welded portion W can be formed on the back support 1 as necessary.

The large number of through holes 10 may be formed by a suitable means such as drilling after the backpack frame 100 is blow-molded. Alternatively, the through holes 10 can be blow-molded in advance. A recess is formed at the position corresponding to the large number of through holes 10 of a metal mold used in the blow molding. The large number of through holes 10 can be formed by cutting a protruded portion formed by the recess.

In another manufacturing method of the backpack frame 100, a disk-like portion including the curved portion 7 and the protruded air intake guide portion 8 can be formed separately from other portions of the back support 1. These components may be fitted and fixed to each other. In this configuration, the sound absorbing material C can be easily filled in the cavity 9 of the back support 1.

The backpack frame 100 is preferably bent at 90° at the flexible thin-walled portion 19 so that the base plate 2 is perpendicular to the back support 1 in an erected posture. Accordingly, the back support 1 and the base plate 2 are preferably assembled in an L-shape as shown in FIGS. 1 and 3. In this assembled condition, inclined surfaces 23 and 24 formed on the back support 1 and the base plate 2, respectively, are closely attached to each other. The assembled condition is preferably maintained by suitable connectors. An example of suitable connectors are bolts. After assembling the backpack frame 100, the machine M is mounted thereon as already described above with reference to FIG. 3.

In a specific operation of the backpack frame 100, the diameter of each of the large number of through holes 10 was set to be 5 mm. The number of the through holes 10 was set to be 220. The actual attenuation of the noise level was measured at the distance of 50 feet away in eight directions in accordance with applicable standards of the American National Standard Institute. The average value of the measured noise level was then obtained. It was confirmed that the noise level was attenuated from 75.5 dB (A) in the configuration having no through holes to 74.6 dB (A) in the configuration having the through holes. This attenuation of about 1 dB (A) means that the sound pressure of the noise is reduced to about one third, and a sufficient effect could be confirmed.

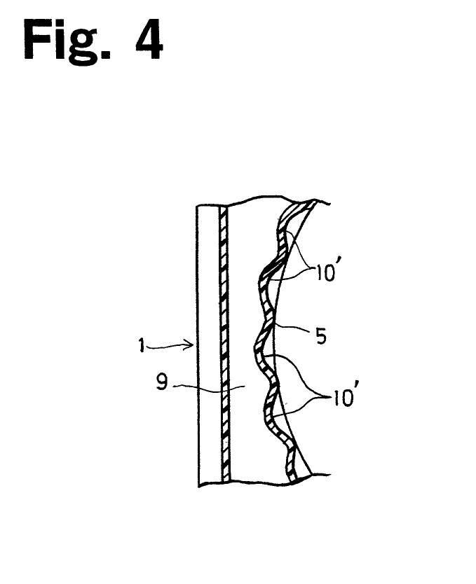

As shown in FIG. 4, a large number of bottomed dimples 10′ with a small diameter may be formed as the intake air muffler in place of the through holes 10. Similar muffling effect can be obtained in this configuration. In addition, the strength of the backpack frame 100 is not degraded, and the backpack frame 100 can be easily manufactured.

In another embodiment, when the inlet port 6a of the centrifugal blower 6 faces the base plate 2, the intake air muffler is disposed on the base plate 2.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A backpack frame for mounting a blower having an inlet port thereon comprising an intake air muffler on a surface facing said inlet port.

2. The backpack frame according to claim 1, wherein said intake air muffler is formed of a large number of through holes communicated with a cavity formed in said backpack frame.

3. The backpack frame according to claim 2, wherein each of said large number of through holes is a through hole with a small diameter having no angular portions.

4. The backpack frame according to claim 2, wherein a sound absorbing material is filled in said cavity.

5. The backpack frame according to claim 1, wherein said intake air muffler is formed of a large number of dimples with a small diameter formed on said surface.

6. The backpack frame according to claim 1, wherein said surface is equipped with an intake air guide portion which is raised toward said inlet port, and the periphery of said intake air guide portion is smoothly curved to increase the air intake efficiency to said inlet port.

7. The backpack frame according to claim 1, wherein the backpack frame is integrally blow-molded in a plate by using a plastic material.

8. A backpack frame for an operator to carry a blower having an inlet port on his back comprising:
(a) a back support;
(b) a base plate; and
(c) an intake air muffler equipped on a surface of said back support or said base plate facing said inlet port.

9. The backpack frame according to claim 8, wherein said intake air muffler is formed of a large number of through holes communicated with a cavity formed in said back support or said base plate.

10. The backpack frame according to claim 9, wherein each of said large number of through holes is a through hole with a small diameter having no angular portions.

11. The backpack frame according to claim 9, wherein a sound absorbing material is filled in said cavity.

12. The backpack frame according to claim 8, wherein said intake air muffler is formed of a large number of dimples with a small diameter formed on said surface.

13. The backpack frame according to claim 8, wherein said surface is equipped with an intake air guide portion which is raised toward said inlet port, and the periphery of said intake air guide portion is smoothly curved to increase the air intake efficiency to said inlet port.

14. The backpack frame according to claim 8, wherein said back support and said base plate are integrated with each other via a flexible thin-walled portion.

15. A backpack type working machine comprising:
(a) a backpack frame with a blower having an inlet port and an engine to drive said blower mounted thereon; and
(b) an intake air muffler equipped on a surface facing said inlet port of said backpack frame.

16. The backpack type working machine according to claim 15, wherein said intake air muffler is formed of a large number of through holes communicated with a cavity formed in said backpack frame.

17. The backpack type working machine according to claim 16, wherein each of said large number of through holes is a through hole with a small diameter having no angular portions.

18. The backpack type working machine according to claim 16, wherein a sound absorbing material is filled in said cavity.

19. The backpack type working machine according to claim 15, wherein said intake air muffler is formed of a large number of dimples with a small diameter formed on said surface.

20. The backpack type working machine according to claim 15, wherein said surface is with an intake air guide portion which is raised toward said inlet port, and the periphery of said intake air guide portion is smoothly curved in order to increase the air intake efficiency to said inlet port.
